(19) United States
(12) Patent Application Publication
(10) Pub. No.: US 2008/0037140 A1
(43) Pub. Date: Feb. 14, 2008

(54) Light-receiving element, optical head using the same, and optical recording/reproducing apparatus using the same

(75) Inventor: Jun Ono, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 11/882,386

(22) Filed: Aug. 1, 2007

(30) Foreign Application Priority Data
Aug. 9, 2006 (JP) 2006-216627

(51) Int. Cl. G01J 1/04; G02B 27/00

(52) U.S. Cl. 359/809; 356/218

(57) ABSTRACT

The invention relates to a light-receiving element for receiving light reflected at an optical recording medium capable of preventing qualitative deterioration of an electrical signal obtained by photoelectric conversion of the light received, an optical head using the element, and an optical recording/reproducing apparatus using the element. The light-receiving element includes a light-receiving portion formed on a silicon substrate, and a cover layer disposed so as to cover an upper side of the silicon substrate, the cover layer on the light-receiving portion having a thickness of 30 μm or less as viewed in the normal direction of the silicon substrate surface.

### BACKGROUND OF THE INVENTION

1. Field of the Invention

The present invention relates to a light-receiving element for receiving light reflected at an optical recording medium, an optical head using the element, and an optical recording/reproducing apparatus using the element.

2. Description of the Related Art

A light-receiving element used in an optical head has a silicon substrate in which a light-receiving portion is formed and a circuit board on which the silicon substrate is disposed. The light-receiving element also has a bonding portion constituted by electrode pads formed on the silicon substrate, electrode terminals formed on the circuit board, and wirings for connecting the electrode pads to the electrode terminals. The light-receiving element also has a cover layer disposed so as to cover an upper side of the light-receiving portion and the bonding portion and extend over the circuit board and the silicon substrate. The cover layer functions as a protective member that prevents corrosion caused by moisture and short circuit failures caused by motes, dust, and the like in air, at the bonding portion.

The cover layer is made of transparent resin, and the layer is configured so that the light-receiving portion can receive light reflected from an optical recording medium. The light-receiving element converts an amount of the light received by the light-receiving portion into an electric signal by photoelectric conversion, and the light-receiving element outputs the electric signal from the bonding portion. On the basis of the electric signal, a reproducing signal including information recorded on the optical recording medium and an error detection signal used in adjustment of a focusing error or a tracking error of the optical head are generated.

Patent Document 1: JP-A-2005-05363

Patent Document 2: JP-A-2006-41456

However, when an optical head is used for a long time, particulates such as motes or dust existing in air occasionally are deposited on a cover layer of a light-receiving element. When the particulates in air are deposited on the cover layer of the light-receiving element, light reflected from an optical recording medium is blocked by the particulates, and so the light is difficult to reach the light-receiving portion. Accordingly, an amount of the light received by the light-receiving element decreases. As a result, the quality of an electric signal obtained from the received light by photoelectric conversion deteriorates, and thus a reproducing signal and an error detection signal of high quality cannot be obtained.

It is an object of the present invention to provide a light-receiving element capable of preventing qualitative deterioration of an electrical signal obtained by photoelectric conversion of the light received by the light-receiving element, an optical head using the element, and an optical recording/reproducing apparatus using the element.

### SUMMARY OF THE INVENTION

The above-described object is achieved by a light-receiving element characterized in that it includes, a light-receiving portion formed on a substrate, and a cover layer disposed so as to cover the substrate and which is formed with a thickness of 30 μm or less as viewed in a normal direction of the substrate surface.

The invention provides a light-receiving element, characterized in that an external surface of the cover layer is formed in substantially parallel to the substrate surface.

The invention provides a light-receiving element, further comprising a circuit board for mounting the substrate thereon, characterized in that the cover layer is formed on the substrate and the circuit board.

The invention provides a light-receiving element, characterized in that the cover layer on the light-receiving portion has a thickness of 0 μm.

The invention provides a light-receiving element, characterized in that the cover layer is made of a transparent material.

The invention provides a light-receiving element, characterized in that the cover layer is made of an opaque material.

The invention provides a light-receiving element, characterized in that the cover layer is made of a resin material.

The invention provides a light-receiving element, characterized in that the resin material is epoxy resin or silicon resin.

The invention provides a light-receiving element, characterized in that the substrate is a silicon substrate.

The above-described object is achieved by an optical head including an objective lens for focusing light radiated from the light source on an optical recording medium, and a light-receiving element for receiving the light reflected from the optical recording medium, characterized in that the light-receiving element is the light-receiving element according to the invention.

The above-described object is achieved by an optical recording/reproducing apparatus characterized in that it includes, the optical head according to the invention.

According to the invention, it is possible to prevent qualitative deterioration of an electrical signal obtained by photoelectric conversion of the light received by a light-receiving element, even when particulates in air are deposited on a light-receiving portion of the light-receiving element.

### BRIEF DESCRIPTION OF THE DRAWINGS

FIGS. 1A and 1B are diagrams illustrating a schematic configuration of a light-receiving element 1 according to an embodiment of the invention;

FIG. 2 is a diagram illustrating advantages of the light-receiving element 1 according to an embodiment of the invention, that is, a graph illustrating relationship between thicknesses of a cover layer on the light-receiving portion and voltage values of electric signals obtained by performing photoelectric conversion of an amount of light received by the light-receiving element 1;

FIGS. 3A and 3B are diagrams illustrating advantages of the light-receiving element 1 according to an embodiment of the invention, in which FIG. 3A is a sectional view of the light-receiving element 1 according to the embodiment, and FIG. 3B is a sectional view of a light-receiving element 31 according to the related art as a comparative example;

FIG. 4 is a sectional view of a light-receiving element 1 according to a modified example of an embodiment of the invention;

FIG. 5 is a diagram illustrating a schematic configuration of an optical head 51 according to an embodiment of the invention; and

FIG. 6 is a diagram illustrating a schematic configuration of an optical recording/reproducing apparatus 150 according to an embodiment of the invention.

### DESCRIPTION OF THE PREFERRED EMBODIMENT

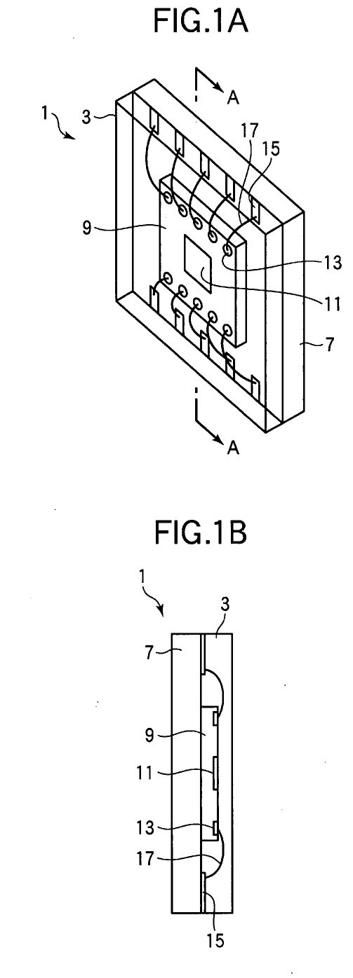

A light-receiving element, an optical head using the element, and an optical recording/reproducing apparatus using the element according to an embodiment of the invention will be described with reference to FIG. 1A to FIG. 6. First, a schematic configuration of the light-receiving element according to the embodiment will be described with reference to FIGS. 1A and 1B. FIG. 1A is an external perspective view of the light-receiving element 1 according to the embodiment. FIG. 1B is a sectional view cut along a virtual line A-A of FIG. 1A.

As shown in FIGS. 1A and 1B, the light-receiving element 1 includes a circuit board 7 having a thin plate shape and a cover layer 3 having a thin plate shape, and the element has a rectangular parallelepiped shape as a whole. A silicon substrate 9 having a thin plate shape is mounted on a substantially central portion of the circuit board 7. The light-receiving element 1 has a light-receiving portion 11 formed in a substantially central portion on a surface of the silicon substrate 9. A transparent protective film (not shown) having a thickness of 0.05 μm to 2 μm is formed on the almost entire surface of the silicon substrate 9 including the light-receiving portion 11. The transparent protective film is made of, for example, SiO₂, SiN, SiON, or the like. The cover layer 3 is formed on the silicon substrate 9 and the circuit board 7, for example, the layer is formed to be laid over both of the silicon substrate 9 and the circuit board 7. The cover layer 3 is disposed on the transparent protective film so as to cover over the silicon substrate 9, and the layer is formed on the light-receiving portion 11 so as to have a thickness of 30 μm or less, for example 30 μm, as viewed in a normal-line direction of a substrate surface of the silicon substrate 9. The thickness of the cover layer 3 is defined as a length from a film surface (a contact surface between the transparent protective film and the cover layer 3) of the transparent protective film on the silicon substrate 9 to an external surface of an incident side of the cover layer 3, as viewed in a normal-line direction of a substrate surface of the silicon substrate 9. The external surface of the cover layer 3 is formed in substantially parallel to the silicon substrate 9 surface. The cover layer 3 is made of, for example, transparent insulating material such as epoxy resin or silicon resin. Thus, the light-receiving element 1 can receive light reflected from the optical recording medium, in the light-receiving portion 11.

The silicon substrate 9 includes a plurality of electrode pads 13 respectively formed along a pair of end sides opposed to each other of the silicon substrate 9. For example, electrode terminals 15 having the same number as the number of the electrode pads 13 are formed on a pair of end sides opposed to each other of the circuit board 7, along the end sides of the silicon substrate 9. The light-receiving element 1 is electrically connected to a mount board (not shown) for mounting the light-receiving element 1, by using the electrode terminals 15. Since the transparent protective film upon the plurality of electrode pads 13 is removed, the plurality of electrode pads 13 is exposed. Thus, the plurality of electrode pads 13 is electrically connected to the plurality of electrode terminals 15 respectively by a plurality of wirings 17. The light-receiving element 1 outputs an electric signal from the electrode pads 13 by performing photoelectric conversion of the received light at the light-receiving portion 11. The electric signal is inputted through the wirings 17 and the electrode terminals 15 into a predetermined circuit on the mounting board on which the light-receiving element 1 is mounted. Additionally, the silicon substrate 9 and the circuit board 7 form a COB (Chip On Board) structure.

The cover layer 3 is formed so as to cover over the bonding portion including the electrode pads 13, the wirings 17, and the electrode terminals 15. The cover layer 3 functions as a protective member that prevents corrosion caused by moisture in the bonding portion and short circuit failures caused by particulates and the like in the bonding portion.

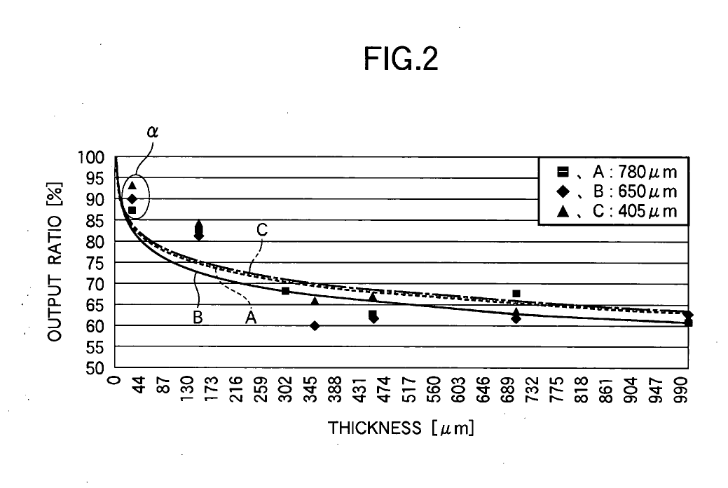

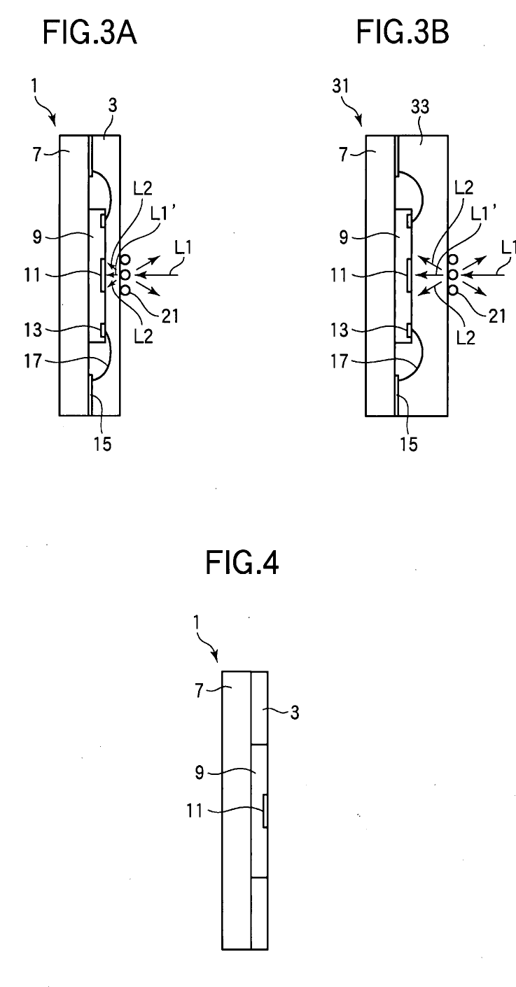

Next, advantages of the light-receiving element according to an embodiment will be described with reference to FIG. 2 to FIG. 3B. FIG. 2 is a graph illustrating relationship between thicknesses of a cover layer on the light-receiving portion and voltage values of electric signals obtained by performing photoelectric conversion of an amount of the received light, when a predetermined amount of particulates are made to be attached to the cover layer on the light-receiving portion. A horizontal axis of the graph represents the thickness (μm) of the cover layer. A vertical axis thereof represents output ratio (=a voltage value of an electric signal after the particulate attachment/a voltage value of an electric signal before the particulate attachment×100)(%) of electric signal obtained by performing the photoelectric conversion of an amount of the light which is made to be incident on the light-receiving portion so that the amount of light is the same before and after making particulates to be attached to the external surface of the cover layer on the light-receiving portion. A sign of ¦ denotes measured values of output ratio of electric signals based on an amount of light of 780 μm wavelength, a sign of ? denotes measured values of output ratio of electric signals based on an amount of light of 650 μm wavelength, and a sign of ? denotes measured values of output ratio of electric signals based on an amount of light of 405 μm wavelength. Additionally, a curve A shows logarithmic approximation of the output ratio characteristics of the electric signal measured at wavelength of 780 μm relative to the thickness of the cover layer, a curve B shows logarithmic approximation of the output ratio characteristics of the electric signal measured at wavelength of 650 μm relative to the thickness of the cover layer, and a curve C shows logarithmic approximation of the output ratio characteristics of the electric signal measured at wavelength of 405 μm relative to the thickness of the cover layer,

Now, the particulates attached to the cover layer will be described in FIG. 2. The optical head including the light-receiving element is generally used indoors. Inspecting grit and dust that exist in indoor air, it was found that the particulates are roughly divided into cotton dust and fugitive dust. Since the cotton dust is larger than the fugitive dust, the cotton dust scarcely enters inside the optical head. Accordingly, influence of the cotton dust upon performance of the light-receiving element can be ignored. Compared with this, since the fugitive dust is relatively smaller than the cotton dust, the fugitive dust can enter inside the optical head and may have influence upon performance of the light-receiving element. Therefore, the particulates having substantially the same particle diameter as the fugitive dust that exists indoors were used in the embodiment. Specifically, the particulates having a diameter of 5 μm to 30 μm may be used, for example, the particulates of which diameter is about 10 μm may be used. In the embodiment, a test powder type 8 (loamy of the Kanto district) based on JIS standard Z8901 was used as the particulates for being attached to the cover layer, and thus the graph illustrated in FIG. 2 was obtained.

As shown in FIG. 2, the output ratio of the electric signals shows a trend to decrease as the thickness of the cover layer increases. The output ratio of the electric signals shows a trend to converge in the range of 60% to 70% thereof when the thickness of the cover layer becomes 300 μm or more. Additionally, the output ratio of the electric signals shows a trend to increase as the thickness of the cover layer becomes smaller than 300 μm and a trend to rapidly increase when the thickness of the cover layer is smaller than 50 μm. In an area surrounded by an ellipse a illustrated in the drawing, the output ratio of the electric signals is 85% or more in the whole three types of wavelengths when the thickness of the cover layer is 30 μm. When the thickness of the cover layer 3 is smaller than 30 μm, the output ratio of the electric signals more increases and becomes almost 100% in the state where the thickness thereof is 0 μm, that is, the cover layer 3 does not exist.

By the way, a photoelectric conversion characteristic that is an electrical characteristic of the light-receiving portion 11 is not affected by existence and nonexistence of the particulates attached to the cover layer on the light-receiving portion. Less susceptibility (or susceptibility) of the light-receiving element to the particulates is represented by the output ratio of the electric signals that are obtained by performing the photoelectric conversion of an amount of the light having the same amount as the light incident on the light-receiving element before and after the particulate attachment. In the case where an amount of decrease in the voltage value of the electric signal after the particulate attachment relative to before becomes smaller, the output ratio of the electric signals becomes larger. For this reason, the light-receiving element having a large output ratio of the electric signal becomes harder to be affected by the particulates attached to the cover layer on the light-receiving portion. Accordingly, as shown in FIG. 2, the light-receiving element becomes harder to be affected by the particulates in the case where the thickness of the cover layer on the light-receiving portion becomes smaller.

Next, factors that make the light-receiving element 1 less susceptible to the particulates when the thickness of the cover layer 3 is small will be described with reference to FIGS. 3A and 3B. FIG. 3A is a sectional view of the light-receiving element 1 according to the embodiment, and FIG. 3B is a sectional view of a light-receiving element 31 according to the related art as a comparative example. As shown in FIGS. 3A and 3B, light L1 that is incident on each of the light-receiving elements 1 and 31 is scattered by particulates 21 attached to external surfaces of cover layers 3 and 33 on the light-receiving portion 11. A part of the light L1 is reflected, and the residual light L1′ is incident on the cover layers 3 and 33.

Scattering light L2 scattered by the particulates 21 is incident on the cover layers 3 and 33 with various incident angles. Accordingly, the incident position of the scattering light L2 is deviated from the incident position of the light L1′ on the light-receiving portion 11 after passing through the cover layers 3 and 33 when the particulates 21 are not attached to the cover layers 3 and 33. The light-receiving element 1 according to the embodiment, the thickness of the cover layer 3 on the light-receiving portion 11 is as small as 30 μm or less. Accordingly, in the light-receiving element 1, difference between the incident position of the scattering light L2 on the substrate surface of the silicon substrate 9 and the incident position of the light L1′ decreases. Consequently, the scattering light L2 is incident on the light-receiving portion 11, so the light-receiving portion 11 can receive a sufficient amount of the scattering light L2, and thus the output ratio of the electric signals increases as shown in FIG. 2.

As compared therewith, the cover layer 33 on the light-receiving portion 11 of the light-receiving element 31 is formed with a thickness, for example, of about 300 μm, and so the thickness of the cover layer 33 is set to be greater than the thickness of the cover layer 3 of the light-receiving element 1. For this reason, the incident position of the scattering light L2 on the substrate surface of the silicon substrate 9 greatly deviates from the incident position of the light L1′. Consequently, the scattering light L2 is hardly incident on the light-receiving portion 11, so the light-receiving portion 11 cannot receive a sufficient amount of the scattering light L2, and thus the output ratio of the electric signals decreases as shown in FIG. 2.

As a result, influence of the particulates attached to the cover layer decreases as the thickness of the cover layer on the light-receiving portion decreases, while influence of the particulates attached to the cover layer increases as the thickness of the cover layer on the light-receiving portion increases.

According to the embodiment as mentioned above, the light-receiving element 1 can prevent decrease of an amount of the light received by the light-receiving portion 11 even when the particulates 21 are attached to the external surface of the cover layer 3, and thus quality of an electric signal obtained by performing photoelectric conversion of an amount of the received light is kept up. As a result, the light-receiving element 1 can prevent qualitative deterioration of an error detection signal for adjusting a focusing error or a tracking error of the optical head and a reproducing signal generated on the basis of the electric signal.

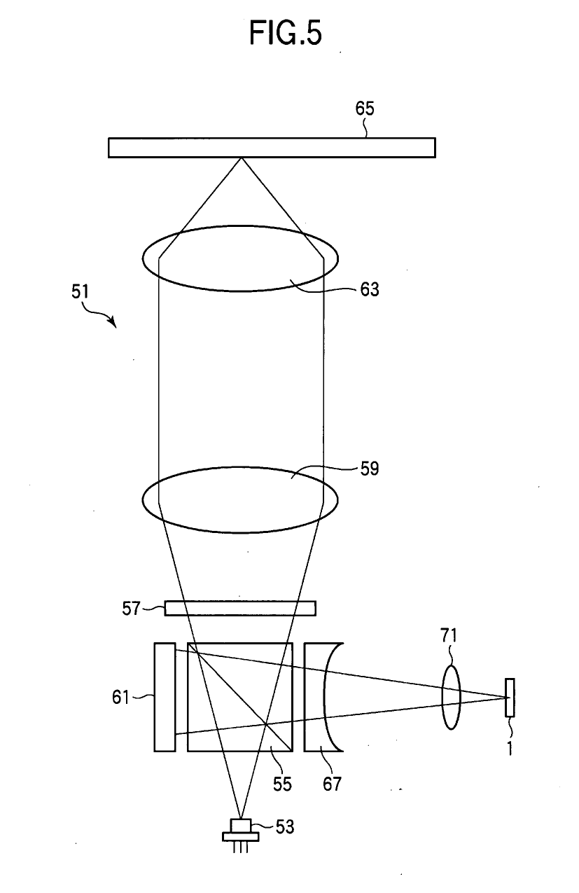

Next, a schematic configuration of a light-receiving element according to a modified example of the embodiments will be described with reference to FIG. 4. In the light-receiving element 1 illustrated in FIGS. 1A and 1B, the cover layer 3 on the light-receiving portion 11 is formed with a thickness of, for example, 30 μm. As compared therewith, in the light-receiving element according to the modified example, it is characterized that the cover layer 3 on the light-receiving portion 11 is formed with a thickness of, for example, 0 μm. In the modified example, in the case where there exist common elements having the same operation or function as the component elements of the light-receiving element 1 illustrated in FIGS. 1A and 1B, those elements will be referenced by the same reference numerals and detailed description thereof will be omitted.

FIG. 4 is a sectional view of the light-receiving element 1 according to the modified example. As shown in FIG. 4, the light-receiving element 1 according to the modified example includes the cover layer 3 of which the thickness on the light-receiving portion 11 is formed with a thickness of 0 μm. In the modified example, the cover layer 3 on the circuit board 7 is formed with a thickness substantially the same as the silicon substrate 9, but the thickness of the cover layer 3 may be set to be greater or smaller than the thickness of the silicon substrate 9. The cover layer 3 is disposed around an outer peripheral edge of the silicon substrate 9 on the circuit board 7. That is, the cover layer 3 is not disposed on the silicon substrate 9, and a transparent protective film (not shown) on the silicon substrate 9 is exposed to air. The cover layer 3 is made of a transparent insulating material such as epoxy resin or silicon resin in the same manner as the cover layer 3 of the light-receiving element 1 illustrated in FIGS. 1A and 1B. However, in the light-receiving element 1 according to the modified example, the cover layer 3 is not disposed on the light-receiving portion 11, and thus a material for forming the cover layer 3 may be an opaque material. Generally, cost of the transparent resin material is about 1.5 to 2 times that of the opaque resin material. Accordingly, by forming the cover layer 3 with an opaque epoxy resin, thereby it is possible to reduce the material cost of the cover layer 3. As a result, in the light-receiving element 1 according to the modified example, a decrease in cost can be contrived as compared with the light-receiving element 1 in FIGS. 1A and 1B.

The silicon substrate 9 is electrically connected to the circuit board 7 by electrode terminals (not shown) formed in the range from a surface of the silicon substrate 9 to the rear surface thereof. With such a configuration, the light-receiving element 1 of the modified example is configured without a bonding portion including electrode pads, wirings, and electrode terminals.

In the light-receiving element 1 of the modified example, the cover layer 3 on the light-receiving portion 11 has a thickness of 0 μm. For this reason, the light scattered by the particulates can be incident on substantially the same position as the position where the incident light in the case of no particulates is incident on the light-receiving portion 11. Accordingly, in the light-receiving element 1 of the modified example as illustrated in FIG. 2, it is possible to get nearly 100% output ratio of voltage values of electric signals obtained by performing the photoelectric conversion of the received light before and after the particulate attachment. By such a configuration, the light-receiving element 1 of the modified example obtains the same advantages as the light-receiving element 1 illustrated in FIGS. 1A and 1B.

Now, peculiar advantages of the light-receiving element 1 obtained by the configuration that the cover layer 3 is not disposed on the light-receiving portion 11 will be described. In an optical head, it is necessary to shorten a light source wavelength in order to increase recording density. For example, the light source wavelength used in compact disk (CD) devices is near 780 nm, but the light source wavelength used in digital versatile disk (DVD) devices is near 650 nm. Now, the light source wavelength has been shortened to near 400 nm. Generally, when the light source wavelength is shortened, optical parts' characteristics such as chromatic aberration, transmittance, and durability are varied, those characteristic variation remarkably increases near 400 nm as a boundary wavelength. Accordingly, even when some optical parts are usable in the range of the light source wavelength used in CD devices and DVD devices, the parts may not be used when using a light source having a wavelength near 400 nm.

Specifically, when short-wavelength light having high power radiates on optical parts, adhesives, and the like using resin as an optical material for a long time, the resin is chemically changed, and the resin is occasionally damaged by a change in resin transmittance, resin deformation, or the like. Additionally, in order to solve the problem mentioned above, it is considerable that a member using glass instead of resin is disposed on a light path of a laser, but there is a problem that needs high processing costs and assembling costs of the parts.

In the light-receiving element 1 of the modified example, the cover layer 3 is not disposed on the light-receiving portion 11. For this reason, the light-receiving element 1 can be configured not to use resin provided as a raw material of the cover layer 3 in the vicinity of the light-receiving portion 11. With such a configuration, the short-wavelength light having high power does not radiate on resin, and thus it is possible to prevent a change in resin transmittance, resin deformation, or the like caused by chemical change of resin in the light-receiving element 1. Additionally, as the degree of difficulty in mounting technique for coating resin decreases, it is not necessary to use an expensive coating device, and thus it is possible to contrive a decrease in cost of facilities for fabricating the light-receiving element 1. For example, the resin can be manually coated without using automatic coating devices.

Next, a schematic configuration of the optical head according to an embodiment will be described with reference to FIG. 5. The optical head 51 is a laser emitting element for emitting a laser beam, for example, includes a laser diode 53. The laser diode 53 is operable to emit laser beams having different light intensity for every recording/reproducing operation on the basis of voltages controlled by a controller (not shown in FIG. 5).

A polarized beam splitter 55 is disposed on a predetermined position of a light emitting side of the laser diode 53. In a light transmitting side of the polarized beam splitter 55 as viewed from the laser diode 53, a quarter wavelength plate 57, a collimator lens 59, and an objective lens 63 are arranged alongside in this order. In a light reflecting side of the polarized beam splitter 55 as viewed from the laser diode 53, a photo diode 61 used in a power monitor for measuring light intensity of a laser beam emitted from the laser diode 53 is disposed. The collimator lens 59 is provided in order to guide a parallel beam into the objective lens 63 by converting a divergent beam from the laser diode 53 into the parallel beam, and to guide a convergent beam into the light-receiving element 1 by converting the parallel beam from the objective lens 63 into a convergent beam. The objective lens 63 is provided in order to form a reading spot by focusing the parallel beam from the collimator lens 59 upon an information recording surface of an optical recording medium 65, and to guide a parallel beam into the collimator lens 59 by converting reflected light from the optical recording medium 65 into the parallel beam.

In a light reflecting side of the polarized beam splitter 55 as viewed from the quarter wavelength plate 57, a sensor lens 67 and cylindrical lens 71 are arranged alongside in this order. In a light transmitting side of the cylindrical lens 71, the light-receiving element 1 for receiving the reflected light from the optical recording medium 65 is disposed. When using the light-receiving element 1 in a practical situation, the substrate surface of the silicon substrate 9 (see FIGS. 1A and 1B) on which the light-receiving portion 11 is formed is disposed in a substantially vertical direction.

The sensor lens 67 functions as a reflected-light focus position adjusting portion for optically adjusting a focusing position of the reflected light from the optical recording medium 65. Additionally, the sensor lens 67 is operable to cause astigmatism in the reflected light from the optical recording medium 65, and to image the reflected light on the light-receiving portion 11 of the light-receiving element 1 by a predetermined optical magnification. The electric signal obtained by photoelectric conversion in the light-receiving element 1 is processed in a predetermined circuit belonging to the optical recording/reproducing apparatus that is not shown, whereby a reproducing signal including information recorded on the optical recording medium 65 may be extracted and an error detection signal for adjusting a focusing error or a tracking error of the optical head 51 may be generated. It is possible to prevent a decrease in an amount of the received light even when the particulates are attached to the light-receiving portion 11 under the environment of using the light-receiving element 1 for a long time. For this reason, the light-receiving element 1 performs photoelectric conversion of light having a sufficient amount of light, and thus it is possible to output electric signals having high quality. With such a configuration, the reproducing signal and the error detection signal generated on the basis of the electric signal does not undergo time degradation, and initial quality of those signals are kept up.

Next, an operation of the optical head 51 will be described. A laser beam of divergent light emitted from the laser diode 53 is incident on the polarized beam splitter 55. In the polarized beam splitter 55, a linear polarized component in a predetermined polarized direction is transmitted through the polarized beam splitter 55, and the linear polarized component is incident on the quarter wavelength plate 57. On the other hand, a linear polarized component orthogonal to the predetermined polarized direction is reflected and incident on the photo diode 61 used in the power monitor, and the laser beam intensity is measured.

The linear polarized light incident on the quarter wavelength plate 57 is transformed into a circular polarized light after passing through the quarter wavelength plate 57. The circular polarized light is converted into parallel light by the collimator lens 59, passes through the collimator lens 59, is converged by the objective lens 63, and is incident on a recording layer of the optical recording medium 65. The circular polarized light reflected from the recording layer of the optical recording medium 65 is converted into parallel light by the objective lens 63, passes through the collimator lens 59, and is incident on the quarter wavelength plate 57. By passing through the quarter wavelength plate 57, the circular polarized light is transformed into linear polarized light of which polarized direction is rotated by 90° with respect to the initial linear-polarized light, and is incident on the polarized beam splitter 55. The linear polarized light is reflected by the polarized beam splitter 55, and is incident on the sensor lens 67.

The light transmitting through the sensor lens 67 is incident on the cylindrical lens 71. The light incident on the cylindrical lens 71 is focused on the light-receiving portion 11 of the light-receiving element 1. It is possible to prevent a decrease in a light amount of the received light even when the particulates are attached to the light-receiving portion 11 under the environment of using the light-receiving element 1 for a long time. In order to generate the reproducing signal and the error detection signal, the electric signal obtained by performing the photoelectric conversion of the received light in the light-receiving element 1 is outputted to a predetermined circuit included in the optical recording/reproducing apparatus.

A light-receiving element 31 according to the related art is mounted on an aluminum plate, and is mounted on the frame of the optical head so as to form a sealed structure by using the aluminum plate as a cover member for sealing itself. With such a configuration, the optical head according to the related art is configured to prevent attaching the particulates in air to the light-receiving element 31. As compared therewith, the light-receiving element 1 according to the embodiment may not be mounted on the optical head so as to form a sealed structure, since the light-receiving element 1 can prevent decrease of voltage values of electric signal obtained by performing the photoelectric conversion of an amount of the received light even when the particulates in air are attached to the cover layer. Accordingly, as the member for sealing the light-receiving element 1 is reduced, the member for the optical head is reduced, and thus it is possible to contrive a decrease in cost of the optical head. Additionally, it is possible to comparatively freely mount the light-receiving element 1 on the optical head, and thus it is possible to improve a degree of freedom in shape designing of the optical head.

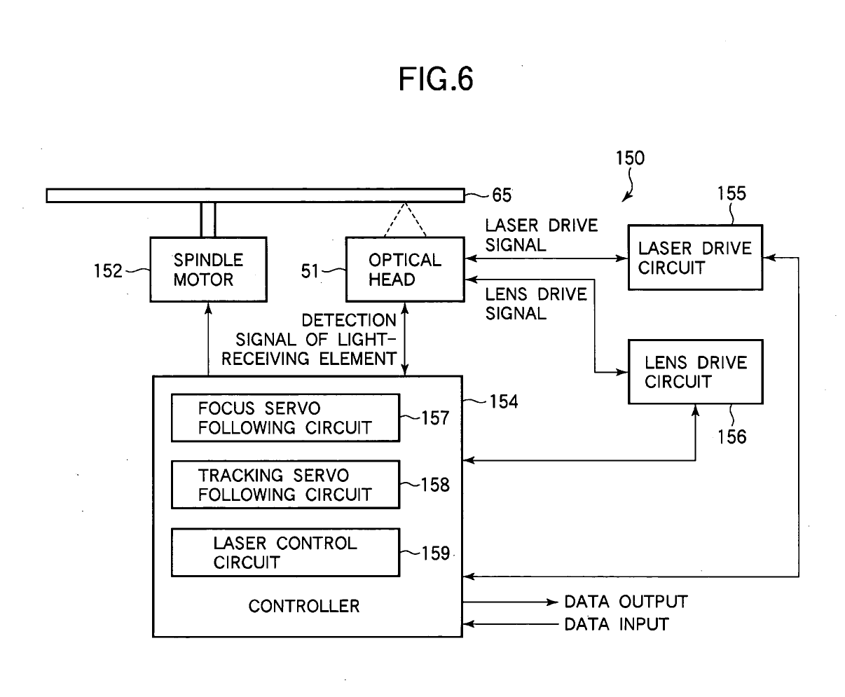

Next, the optical recording/reproducing apparatus according to an embodiment will be described with reference to FIG. 6. For example, the optical recording/reproducing apparatus includes an optical head device for recording information in predetermined regions of a plurality of tracks formed along the circumferential direction of a disk-shaped optical recording medium so as to repeat in the radial direction of the optical recording medium and for reproducing information recorded in predetermined regions of the tracks. As for the optical head, there is a record-only type for recording information only upon the optical recording medium, a reproduce-only type for reproducing information only, and a record/reproduce type for both recording and reproducing. Hereinafter, including optical recording apparatus, optical reproducing apparatus, and optical recording/reproducing apparatus, which are equipped with the optical head types, respectively, it is referred to as the optical recording/reproducing apparatus.

FIG. 6 is a diagram illustrating a schematic configuration of an optical recording/reproducing apparatus 150 equipped with an optical head 51 according to the embodiment. As shown in FIG. 6, the optical recording/reproducing apparatus 150 includes a spindle motor 152 for rotating the optical recording medium 65, an optical head 51 for receiving the reflected light while irradiating a laser beam on the optical recording medium 65, a controller 154 for controlling the spindle motor 152 and the optical head 51, a laser drive circuit 155 for supplying a laser drive signal to the optical head 51, and a lens drive circuit 156 for supplying a lens drive signal to the optical head 51. When using the light-receiving element 1 (see FIGS. 1A and 1B) included in the optical head 51 in a practical situation, the substrate surface of the silicon substrate 9 (see FIGS. 1A and 1B) on which the light-receiving portion 11 is formed is disposed in a substantially vertical direction.

The controller 154 includes a focus servo following circuit 157, a tracking servo following circuit 158, and a laser control circuit 159. When the focus servo following circuit 157 is operated, a laser beam is focused on an information recording surface of the rotating optical recording medium 65. When the tracking servo following circuit 158 is operated, a laser beam spot automatically follows eccentric signal tracks on the optical recording medium 65. The focus servo following circuit 157 and the tracking servo following circuit 158 have auto gain control functions for automatically adjusting a focus gain and a tracking gain, respectively. Additionally the laser control circuit 159 is a circuit for generating the laser drive signal supplied by the laser drive circuit 155, and generates an adequate laser drive signal on the basis of information of record condition setting recorded on the optical recording medium 65.

The focus servo following circuit 157, the tracking servo following circuit 158, and the laser control circuit 159 are not necessary to be a circuit built in the controller 154, and may be configured as a separate component independent from the controller 154. Additionally, those are not necessary to be a physical circuit, and may be configured as software executed by the controller 154.

The invention is not limited to the embodiments mentioned above, and may be modified to various forms.

For example, the light-receiving element 1 according to the modified example of the embodiment includes the cover layer 3 disposed around the silicon substrate 9, but the invention is not limited to this configuration. The light-receiving element 1 according to the modified example does not include the bonding portion, and thus it is possible to prevent corrosion caused by moisture and short circuit failures caused by particulates in air, in the bonding portion. With such a configuration, it is possible to attain the same advantages as the modified example of the embodiment even when the light-receiving element 1 does not include the cover layer 3.

The light-receiving element 1 according to the embodiment employs the silicon substrate 9 as a substrate for forming the light-receiving portion 11, but the invention is not limited to this configuration. For example, it is possible to attain the same advantages even when the light-receiving element employs a SOI (Silicon on Insulator) substrate for forming the light-receiving portion.

What is claimed is:

1. A light-receiving element comprising:
a light-receiving portion formed on a substrate; and
a cover layer disposed so as to cover the substrate and which is formed with a thickness of 30 μm or less as viewed in a normal direction of the substrate surface.

2. The light-receiving element according to claim 1, wherein an external surface of the cover layer is formed in substantially parallel to the substrate surface.

3. The light-receiving element according to claim 1, further comprising a circuit board for mounting the substrate thereon, wherein the cover layer is formed on the substrate and the circuit board.

4. The light-receiving element according to claim 3, wherein the cover layer on the light-receiving portion has a thickness of 0 μm.

5. The light-receiving element according to claim 1, wherein the cover layer is made of a transparent material.

6. The light-receiving element according to claim 4, wherein the cover layer is made of an opaque material.

7. The light-receiving element according to claim 5, wherein the cover layer is made of a resin material.

8. The light-receiving element according to claim 7, wherein the resin material is epoxy resin or silicon resin.

9. The light-receiving element according to claim 1, wherein the substrate is a silicon substrate.

10. An optical head comprising:
an objective lens for focusing light radiated from the light source on an optical recording medium; and
a light-receiving element for receiving the light reflected from the optical recording medium,
wherein the light-receiving element is the light-receiving element according to claim 1.

11. An optical recording/reproducing apparatus comprising the optical head according to claim 10.
